(19) United States
(12) Patent Application Publication
(10) Pub. No.: US 2012/0073908 A1
(43) Pub. Date: Mar. 29, 2012

(54) FRICTION DRIVE LIFT

(75) Inventor: Dov Rosenthal, Amstelveen (NL)

(73) Assignee: HANDICARE STAIRLIFTS B.V., Heerhugowaard (NL)

(21) Appl. No.: 13/246,164

(22) Filed: Sep. 27, 2011

(30) Foreign Application Priority Data
Sep. 27, 2010 (NL) 2005398

(51) Int. Cl. B66B 9/08

(52) U.S. Cl. 187/201

(57) ABSTRACT

A stair lift for transporting a load includes a longitudinal guide having a first side running surface and a second side running surface opposing the first side running surface; and a carriage which is transportable along the guide and provided with rollers for guiding the carriage along the guide. The rollers include a first roller having a first roller peripheral friction surface which is in frictional engagement with the first side running surface for guiding the carriage along the guide and a second roller having a second roller peripheral friction surface which is in frictional engagement with the second side running surface for guiding the carriage along the guide. The first roller friction surface is provided with a first roller member, and the first side running surface is provided with a longitudinal first side running surface member which fits complementary with the first roller member.

### CROSS-REFERENCE TO RELATED APPLICATIONS

This application claims the benefit of Netherlands Application No. 2005398, filed Sep. 27, 2010, the contents of which is incorporated by reference herein.

### FIELD OF THE INVENTION

The present invention relates to a stair lift for transporting a load.

### BACKGROUND OF THE INVENTION

Stair lifts are well known and are particularly used for transporting loads such as persons and/or goods up or down over a stairs by being carried on a chair or a platform. In general a stair lift comprises of a guide or rail to be attached along a staircase and a motorized carriage or trolley which carries and guides the load along the rail.

Stair lifts may be driven by friction drive rollers which are in frictional engagement with the guide. These have proven to be less expensive than form fitted drive means such as sprocket and chains or rack and pinion.

For example, a stair-climbing device is known from patent publication EP-0,881,188-A1. This publication shows a stair-climbing device comprising a guiding rail and a trolley movable on the guiding rail. The stair-climbing device is further provided with a motor that drives a drive roller supported by the trolley, wherein the drive roller is in frictional engagement with the guiding rail. Each longitudinal side of the guiding rail is in frictional engagement with a guiding roller to keep the trolley in a predetermined position with respect to the guided rail. Each drive roller is provided with a means for pressing the drive roller into frictional engagement.

Drawback of these known stair lifts is that they are mechanically complex.

### SUMMARY OF THE INVENTION

It is an object of the present invention to eliminate at least one of the abovementioned problems or at least provide an alternative.

In particular, it is an object of the present invention to simplify the state of art stair lifts. The object is achieved by a stair lift according to the invention. This stair lift for transporting a load, comprises a longitudinal guide comprising a first side running surface and a second side running surface opposing the first side running surface. The stair lift furthermore comprises a carriage which is transportable along the guide. The carriage is provided with rollers for guiding the carriage along the guide. The carriage comprises a first roller comprising a first roller peripheral friction surface which is in frictional engagement with the first side running surface for guiding the carriage along the guide. The carriage also comprises a second roller comprising a second roller peripheral friction surface which is in frictional engagement with the second side running surface for guiding the carriage along the guide. Now, the first roller friction surface is provided with a first roller member which peripherally extends in a plane perpendicular to a rotational axis of the first roller. The first side running surface is provided with a longitudinal first side running surface member which fits complementary with the first roller member for supporting the first roller on the first side running surface.

By having the first roller peripheral friction surface of the first roller provided with the first roller member and the first side running surface of the guide provided with the first side running surface member, the first roller is supported by the guide. This has as advantage that the weight of the load is at least partly carried by the guide by means of the first roller. The first roller member offers an extra restriction in movement. In the state of art, the first roller peripheral friction surface only guides the first roller by restricting a movement perpendicular to the first roller peripheral friction surface and the first side running surface. Now, the first roller member results in an extra movement restriction, namely a movement parallel to the first roller peripheral friction surface and parallel to the first side running surface and perpendicular to a roller rolling direction. The roller rolling direction being in the direction of the length of the guide. This may result in a more simple stair lift as other rollers, e.g. rollers comprising a horizontal rotational axis, may carry less weight and/or may be designed more lightly, and/or the number of such rollers with a horizontal rotational axis may be decreased.

The first side running surface of the guide is longitudinal and preferably the length of the first side running surface defines a distance between a start point and an end point for transporting the load. In a further preference, the length of the first side running surface is substantially parallel to a longitudinal axis of the guide.

In a preference, the first side running surface is facing the second side running surface thus being parallel to each other. In another preference, the first side running surface or the second side running surface is in a vertical plane, i.e. a plane comprising the gravitational direction. Alternatively, the first side running surface or the second side running surface are inclined with respect to the vertical plane and defining an angle substantially smaller than 45 degrees, more particularly smaller than 20 degrees and even more particular smaller than 5 degrees.

Preferably, the first roller peripheral friction surface is provided with the first roller member which peripherally extends inwards or outwards in the plane perpendicular to the rotational axis of the first roller. The rotational axis is the axis of rotation and is provided along the centre line of the roller. Peripherally extending meaning extending from the circumference of the first roller defined by the first roller peripheral surface. Extending may be extending inwards or outwards. The first roller member may extend from substantially the whole circumference, i.e. 360 degrees or may in an alternative be interrupted by small gaps. The small gaps are that small that the first roller remains suitable for being supported by the first side running surface member.

In an embodiment, the first roller member is an outwards peripherally extending protrusion, for example a first roller flange. The first roller flange is received by the first side running surface member. In this embodiment, the first side running surface member is a longitudinal recess, for example a first side running surface groove. The longitudinal recess extends inwards away from the first roller. The first roller member is a first roller flange and the first side running surface member is a first side running surface recess which receives the first roller flange. This has as advantage that the guide may be manufactured by easy and cheap extrusion.

In an alternative, the first roller is an inwards peripherally extending recess, for example a first roller groove. The first roller groove receives the first side running surface member. In this alternative embodiment, the first side running surface member is a longitudinal protrusion, for example a first side running surface ridge. The longitudinal protrusion extends outwards towards the first roller. The first roller member is a first roller groove and the first side running surface member is a first side running surface ridge which is received by the first roller groove. This has as advantage that the guide may be manufactured by easy and cheap extrusion.

The shape of the first roller member may be of any shape. For example, the first roller member may be V-shaped or U-shaped. The shape is defined at an outer end when the first roller is the outwards peripherally extending protrusion. The shape is defined at an inner end when the first roller is the inwards peripherally extending recess. In an embodiment the first roller flange has a point shape outer end and the first side running surface recess has a complementary V-shape inner end. This has as advantage that the guide may be manufactured by easy and cheap extrusion.

The shape of the first side running surface member may be of any shape. For example, the first side running surface may be V-shaped or U-shaped. This shape is defined at an outer end when the first side running surface is the longitudinal protrusion. This shape is defined at an inner end when the first side running surface is the longitudinal recess. In an embodiment the first roller groove has a point shape inner end and the first side running surface ridge has a complementary V-shape outer end. This has as advantage that the guide may be manufactured by easy and cheap extrusion.

In an embodiment of the stair lift according to the invention, the guide comprises a topside surface and a downside surface. The topside surface and downside surface are longitudinal sides of the guide and are provided between the first side running surface and the second side running surface. In an embodiment, the topside surface and the downside surface are suitable for frictional engagement with horizontal rollers comprising a horizontal rotational axis.

In an embodiment, the carriage is free from rollers engaging the topside surface and the downside surface. As the first roller member fits complementary with the first side running surface member, the stair lift may be free of rollers in frictional engagement with the topside surface and the downside surface of the guide. More particular, the stair lift is free from horizontal rollers comprising a horizontal rotational axis. In the state of art, rollers engaging the topside surface and downside surface are used to support the carriage, i.e. carry the weight of the carriage. According to this embodiment, the carriage is supported by the first side running surface, by means of the first roller member and the first side running surface member. The second roller provides a counter force at the second side running surface such that the carriage does not move sideways.

This has advantage that less rollers may be needed such that wearing may occur less often and maintenance such as replacing parts with spare parts may be more easy. A further advantage is a reduction of costs and increase ease of manufacturing. Another advantage is that less rollers may result in a reduction of sound. This is particular advantageous for a user of the stair lift.

In an embodiment of the stair lift according to the invention, the carriage is provided with a first drive. The first drive is in a driveable connection with the first roller such that the carriage is driveable by means of friction between the first roller peripheral friction surface and the first side running surface.

This has as advantage that the carriage may be transported more efficiently along the guide in terms of energy. The first roller member and the first side running surface provided more friction between the first roller and the first side running surface. This results in more grip between the first roller peripheral friction surface and the first side running surface. More grip may result in a more efficiently transported carriage in terms of energy.

Preferably, the first drive is a motor, for example an electric motor for driving the first roller rotational axis or spinning axis. As the first roller peripheral friction surface contacts the first side running surface of the guide, the first roller is in a frictional engagement with the guide. By rotating or spinning the first roller, the first roller peripheral friction surface rolls over the first side running surface such that the carriage is transported with respect to the guide.

In an embodiment of the stair lift according to the invention the stair lift further comprises a load carrier. A centre of gravity of the load carrier lies outwards from the second side running surface. The first roller member and the complementary first side running surface member are arranged higher than the second roller and the second side running surface.

This has as advantage that a more rigid guiding and support of the carriage along the guide may be possible. When the load, for example a person, is placed on the load carrier the resulting gravitational force of the load and the load carrier results in a first moment of force with its rotational axis parallel to a length of the guide as the centre of gravity of the load carrier and the load lies outwards from the second side running surface. Outwards meaning away from the guide and the first side roller surface. As the first roller is placed higher than the second roller the moment of forces pushes the first roller into the guide. Particularly, the first roller may press against the first running surface as they are in a frictional engagement. More friction between the peripheral frictional surface of the first roller and the first running surface is generated which may result in a more solid and rigid guiding and support of the carriage along the guide.

In particular the load carrier extends outwards seen from the second side running surface. Outwards being a direction perpendicular to the second side and away from the first side surface and towards the centre of gravity of the load carrier and the load.

Preferably, the first roller is arranged above a line through the centre of gravity of the guide and parallel to the guide, wherein the second roller is arranged below this line.

This has as advantage that the stair lift may be more compact, not taking too much space.

Alternatively, the first roller is arranged above a centre line of the guide and the second roller is arranged below the centre line of the guide.

Preferably, the first roller is arranged near a top of the guide and the second roller is arranged near a bottom of the guide, increasing the distance between the first roller and the second roller and thus increasing a pressing of the first roller in the first running surface and the second roller in the second running surface.

This has as advantage that an even more solid and rigid guiding and supporting of the carriage may be possible.

In a particular advantageous embodiment of the stair lift according to the invention, the carriage is provided with the first drive. The first drive is in a driveable connection with the first roller such that the carriage is driveable by means of friction between the first roller peripheral friction surface and the first side running surface. Furthermore, the stair lift comprises the load carrier. A centre of gravity of the load carrier lies outwards from the second side running surface. The first roller member and the complementary first side running surface member are arranged higher than the second roller and the second side running surface.

This has as advantage that carriage may be transported even more efficiently along the guide in terms of energy. The first roller member and the first side running surface provided more friction between the first roller and the first side running surface. This results in more grip between the first roller peripheral friction surface and the first side running surface. More grip may result in a more efficiently transported carriage in terms of energy. As the first roller is placed higher than the second roller the first moment of force pushes the first roller into the guide. Particularly, the first roller presses against the first running surface as they are in a frictional engagement. Thus more friction between the peripheral frictional surface of the first roller and the first running surface is generated also resulting in more grip.

In an embodiment of the stair lift according to the invention the second roller friction surface is provided with a second roller member which peripherally extends in a plane perpendicular to a rotational axis of the second roller and the second side running surface of the guide is provided with a longitudinal second side running surface member which fits complementary with the second roller member for supporting the second roller along the second side running surface.

By having the second roller peripheral friction surface of the second roller provided with the second roller member and the second side running surface of the guide provided with the second side running surface member, the second roller is supported by the guide. This has as advantage that the weight of the load is at least partly carried by the guide by means of the second roller. The guide also at least partly supports the carriage by means of the first roller. The second roller offers a restriction in movement, namely a movement parallel to the second roller peripheral friction surface and parallel to the second side running surface. This may result in a more simple stair lift as other rollers, e.g. rollers comprising a horizontal rotational axis may carry less weight.

In a further embodiment the carriage is provided with a second drive that is in a driveable connection with the second roller such that the carriage is driveable by means of friction between the second roller and the second running surface.

This has as advantage that the carriage may be transported more efficiently along the guide in terms of energy. The second roller member and the second side running surface provide more friction between the second roller and the second side running surface. This results in more grip between the second roller peripheral friction surface and the second side running surface. More grip may result in a more efficiently transported carriage in terms of energy. Moreover, having two rollers in drivable connection with a drive increases the safety. If one roller fails, the other can still move or at least brake the carriage with respect to the guide.

Preferably, the second drive is a motor, for example an electric motor for driving the second roller rotational axis or spinning axis. As the second roller peripheral friction surface contacts the second side running surface of the guide, the second roller is in a frictional engagement with the guide. By rotating or spinning the second roller, the second roller peripheral friction surface rolls over the second side running surface such that the carriage is transported with respect to the guide.

In an embodiment of the stair lift according to the invention the carriage is provided with a third roller. The third roller comprises a third roller peripheral friction surface which is in frictional engagement with the second side running surface for guiding the carriage along the guide.

Having the third roller allows for a distribution of a second moment of force around an axis parallel to the gravitational direction. This second moment of force is generated as a result of an a-symmetrical load, being a load which acts outside a centre of gravity of the guide, resulting in forces and moments of forces that must safely be distributed over the rollers. In particular, the second moment of force is generated when the guide is inclined with respect to a horizontal plane and a load has its centre of gravity outwards from the second side running surface. Outwards meaning in a direction away from the first side running surface and the second side running surface. Advantageous of the third roller is that it restricts an unwanted rotation of the carriage with respect to the guide around the axis parallel to the gravitational direction.

In a further embodiment the first roller is arranged in a direction along the guide between the second roller and the third roller.

The first roller is in frictional engagement with the first side running surface. The second roller and the third roller are in frictional engagement with the second side running surface, being an opposing side with respect to the first side running surface. Seen along the direction of the guide, being in the longitudinal direction of the guide, the first roller is in engagement with the first side running surface between the second roller and the third roller. This has as result that a distance between the first roller and the second roller is equal to a distance between the first roller and the third roller. This has as advantage that the second moment of force does not result in an unwanted rotation of the carriage with respect to the guide around an axis parallel to the gravitational direction, independent from a direction of rotation of the second moment of force.

In a preference, the third roller is driven by a third drive. Having three rollers in drivable connection with a drive increases the safety. If one or two rollers fail, the other can still move or at least brake the carriage with respect to the guide.

In another further embodiment the carriage is provided with a fourth roller, wherein the fourth roller comprises a fourth roller peripheral friction surface which is in frictional engagement with the first side running surface for guiding the carriage along the guide.

Having the fourth roller results in that two rollers are arranged at the first side running surface and two rollers are arranged at the second side running surface. This has as advantage that the second moment of force does not result in an unwanted rotation of the carriage with respect to the guide around an axis parallel to the gravitational direction, independent from a direction of rotation of the second moment of force.

In a preference, the fourth roller is driven by a fourth drive. In a further preference, the fourth roller comprises a fourth roller member that is in frictional engagement with a complementary second side running surface member.

In another further embodiment the stair lift further comprises a load carrier, wherein a centre of gravity of the load carrier lies outwards from the second side running surface and wherein the first roller is arranged opposite to the third roller or the second roller.

This has as advantage that the second moment of force is distributed to the first roller, second roller and third roller in an optimal manner. This arrangement of the load carrier results in the a-symmetric load. Depending on an inclination of the guide this results in a certain direction of rotation of the second moment of force. The inclination may be such that a first end of the guide is arranged lower than a second end of the guide or vice versa that the second end is arranged lower than the first end. Having the first roller opposite to the second roller or the third roller ensures that a distance between respectively the first roller and the third roller or the first roller and the second roller is maximized. This is advantageous because having this maximized distance ensures that the second moment of force is distributed and spread over the rollers. This means that forces due to the second moment of force acting on the guide by the rollers is minimized.

All the embodiments, further embodiments, particularly advantageous embodiments and preferences described above and below regarding the first roller, first roller member, complementary first side running surface member, first side running surface and first drive also correspond mutatis mutandis to respectively the second roller, second roller member, complementary second side running surface member, second side running surface and second drive, the third roller, third roller member, complementary third side running surface member, third side running surface and third drive, the fourth roller, fourth roller member, complementary fourth side running surface member, fourth side running surface and fourth drive.

In an embodiment of the stair lift according to the invention the carriage is free from active pressure means. Advantage is that this may result in a more easy manufacturing and maintenance of the stair lift. This may reduce the weight and complexity of the carriage which may result in a more safe and more cheap stair lift.

Active pressure means for increasing the friction between the first roller and the first running surface are replaced by friction increasing features such the first roller member fitting complementary with the first side running surface member. Active pressure means are for example spring actuated counter rollers. In particular, active pressure means may be omitted in an embodiment with the first roller being higher than the second roller. Thanks to this relative position of the rollers, a force moment induced by a load on the stair lift presses both rollers on the guide, so they remain in engagement even if they become reduced in size due to wear.

In an alternative embodiment, the stair lift is provided with a minimum of active pressure means that are redundant or supplementary to the friction increasing features of the invention.

In an embodiment of the stair lift according to the invention, the first roller member comprises an upper member side surface and a lower member side surface. The upper member side surface angle defined between the upper member side surface and an auxiliary plane perpendicular to the rotational axis of the first roller is larger than a lower member side surface angle defined between the lower member side surface and the auxiliary plane.

The upper member side surface and the lower member side surface form the first roller member. The upper member side surface originates and extends from the first roller peripheral surface at an upper member side surface origin. The lower member side surface originates and extends from the first roller peripheral surface at a lower member side surface origin. The upper member side surface origin is higher the lower member side surface origin. The upper member side surface and the lower member side surface make an angle with the auxiliary plane such that they approach each other and form a peripheral outer line being a cutting line. Having the angle between the upper member side surface and the auxiliary plane larger than the angle between the lower member side surface and the auxiliary plane results in that the peripheral outer line lies below a middle of the upper member side surface origin and the lower member side surface origin. Here, below is seen in a direction along the gravitational direction.

This has as advantage that it results in a better support in the gravitational direction as the lower member side surface is less oblique to the gravitational direction compared to the upper member side surface such that the carriage is better supported by the guide. Less oblique in this context means nearer to a perpendicular arrangement with respect to the gravitational direction.

In an embodiment of the stair lift according to the invention, the first roller is provided with a plurality of first roller members and the first side running surface of the guide is provided with a plurality of first side running surface members which supports the plurality of first roller members.

Advantage of this embodiment is that the stair lift may result in a more simple stair lift. The plurality of first roller members corresponding with the plurality of first side running surface members increases support of the first roller by the first side running surface. This has as advantage that each first side running surface member is redundant which may increase safety.

The plurality of first roller members is arranged in parallel planes, each plane being perpendicular to the rotational axis of the first roller. Each first roller member peripherally extends in the plane perpendicular to the first roller rotational axis. The first roller rotational axis is provide along the centre line of the first roller. The corresponding plurality of longitudinal first side running surface members is arranged in the corresponding parallel planes.

In another embodiment of the stair lift according to the invention the guide is an aluminium extruded rail. This has as advantage that the rail may be easier and more cheap to manufacture.

The present invention also relates to a method for transporting a load over a staircase by means of a stair lift according to the invention. The method comprises the step of guiding the carriage along the guide from a start point to an end point.

By having the first roller peripheral friction surface of the first roller provided with the first roller member and the first side running surface of the guide provided with the first side running surface member, the first roller is supported by the guide. This has as advantage that the weight of the load is at least partly carried by the guide by means of the first roller. The first roller offers an extra restriction in movement. In the state of art, the first roller peripheral friction surface only guides the first roller by restricting a movement perpendicular to the first roller peripheral friction surface and the first side running surface. Now, the first roller member results in an extra movement restriction, namely a movement parallel to the first roller peripheral friction surface and parallel to the first side running surface and perpendicular to a roller direction. The roller direction being in the direction of the length of the guide. This may result in a more simple stair lift as other rollers, e.g. rollers comprising a horizontal rotational axis may carry less weight.

These and further embodiments of the stair lift and the method according to the invention are described herein.

### BRIEF DESCRIPTION OF THE DRAWINGS

These and other aspects, characteristics and advantages of the present invention will be explained in more detail by means of the following description of two embodiments of the stair lift according to the invention, in which identical reference numerals denote identical components, and in which:

FIG. 1 shows a perspective view of a first embodiment of a stair lift according to the invention and a staircase;

FIG. 2 shows a more detailed perspective view of the first embodiment;

FIG. 3 shows a front view of the first embodiment;

FIG. 4 shows a detail of the front view of the second embodiment;

FIG. 5 shows a first side view of the first embodiment;

FIG. 6 shows a second side view of the first embodiment;

FIG. 7 shows a perspective view of a second embodiment of a stair lift according to the invention;

FIG. 8 shows a perspective view from another viewing angle of the second embodiment;

FIG. 9 shows a perspective view similar to FIG. 8 in which components are more conveniently shown;

FIG. 10 shows a front view of the second embodiment;

FIG. 11 shows a side view of the second embodiment; and

FIG. 12 shows a more detailed front view.

### DETAILED DESCRIPTION OF THE INVENTION

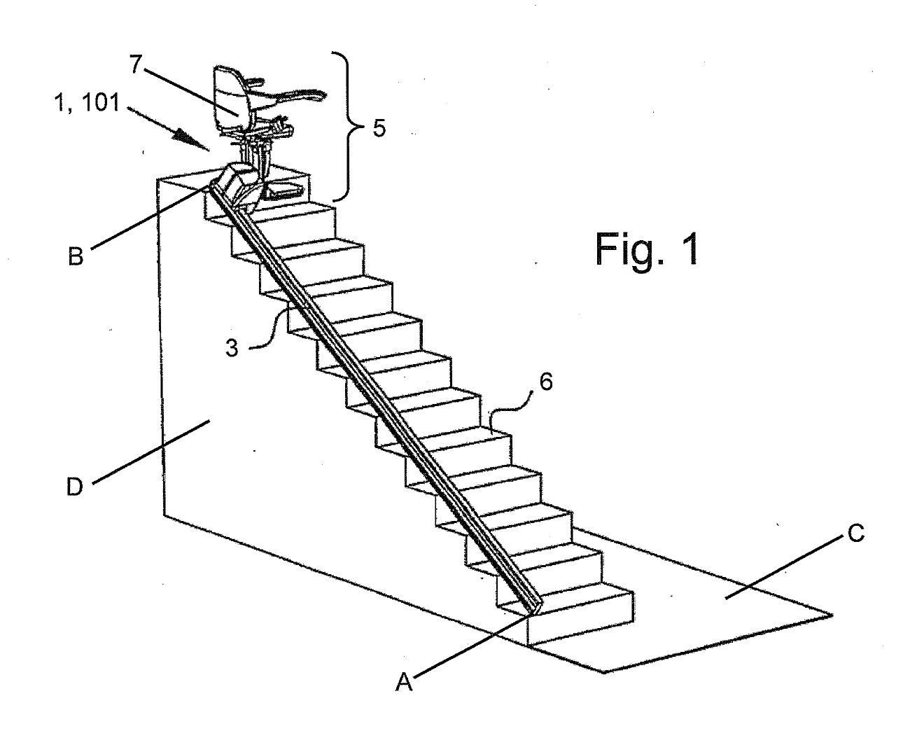

FIG. 1 shows a stair lift 1 according to the first embodiment of the invention and comprises a guide 3 and a carriage 5. The guide 1 is arranged along a staircase 6. The staircase may be used by a person to transport himself from a start point to an end point or vice versa. In FIG. 1 it is shown that the guide 1 is arranged from start point A to start point B. When the person is handicapped or for other reasons unable to use the staircase 6, the person may use the stair lift 1 to be transported from start point A to end point B or vice versa. In this embodiment the stair lift 1 further comprises a load carrier 7 in the form of a seat. The load carrier 7 may be used by the person to sit on. Particularly, when the person is seated in the load carrier 7 the person may be transported between start point A and end point B or vice-versa. Alternatively, the load carrier 7 is a flat platform for carrying a wheel chair or goods. In FIG. 1 the guide 3 is shown as a straight rail.

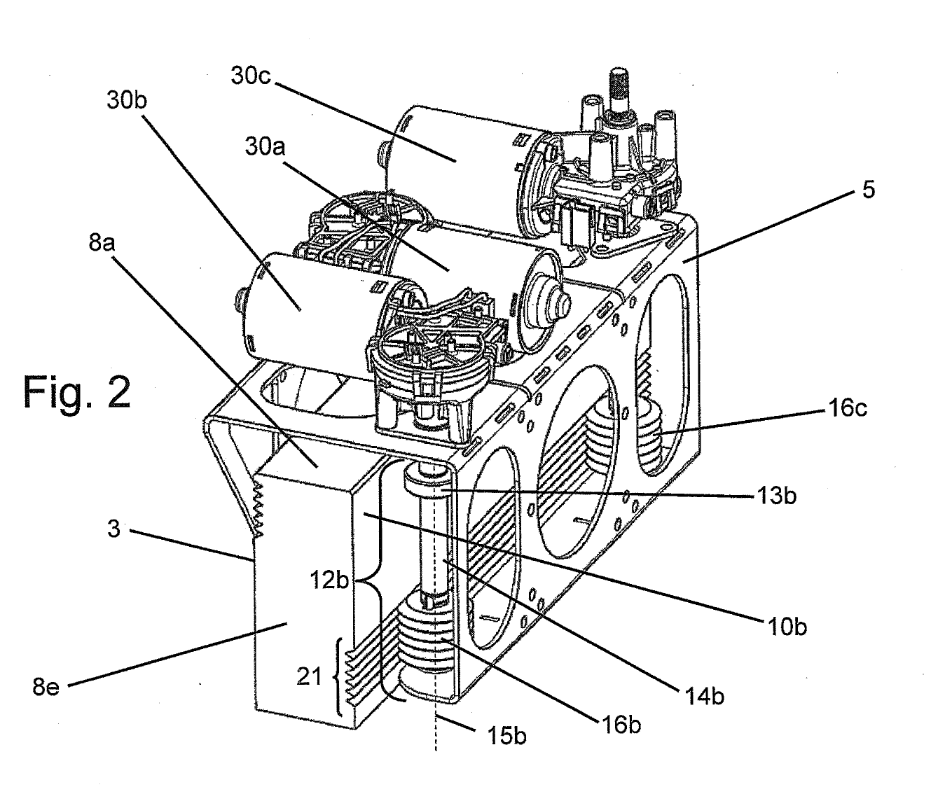

FIG. 2 shows a perspective view of the stair lift 1, showing a part of the guide 3 and part of the carriage 5. The load carrier 7 which forms part of the stair lift 1 is not shown. The shown guide 3 is a longitudinal beam with six sides. Although, the guide 3 is shown as a beam with rectangular sides, the beam may also have different cross sections such as but not limited to a trapezoid beam or an I-beam.

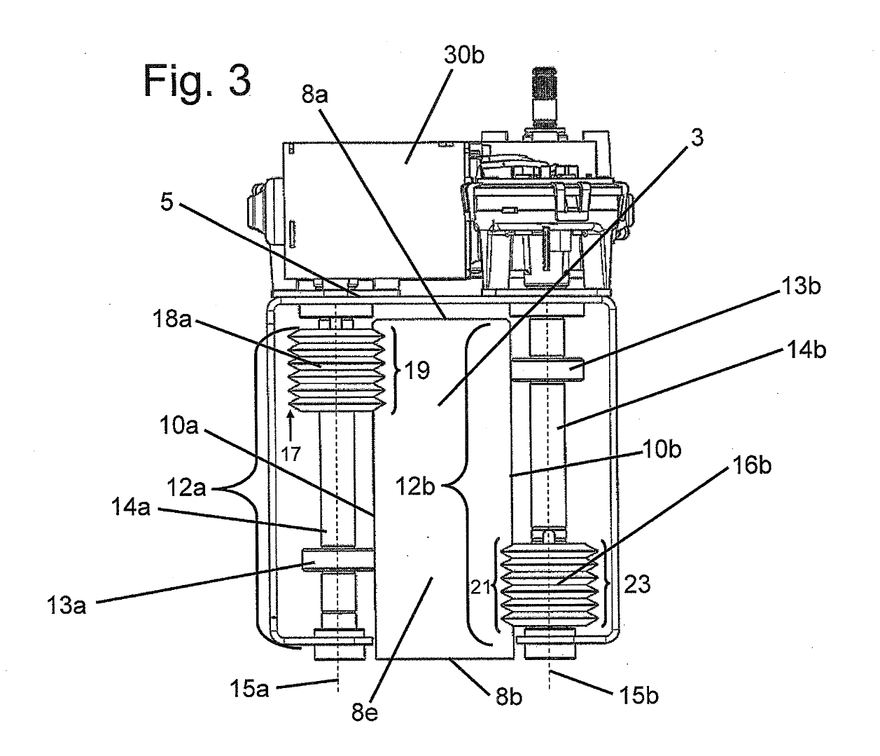

The guide 3 comprises a topside 8a and a downside 8b. The downside 8b can be seen in FIG. 3. The topside 8a is opposite and parallel to the downside 8a. The topside 8a and the downside 8b are longitudinal sides. The guide 3 also has a first side surface 8c comprising a first side running surface 10a and a second side surface 8d comprising a second side running surface 10b. The first side running surface 10a and the second side running surface 10b are also longitudinal and are arranged parallel to the vertical plane D preferably comprising the gravitational direction. The topside 8a and downside 8b are arranged between and perpendicular to the first side running surface 10a and the second side running surface 10b. The first side running surface 10a is facing and parallel to the second side running surface 10b. Furthermore, the guide 3 comprises a first end 8e and a second end 8f arranged at both ends of the guide 3. This completes a six sided beam along which the carriage 5 can be transported.

The carriage 5 is provided with rollers for driving the carriage 5 and is thereby transportable along the guide 3. The rollers are for example wheels having a rotational axis. The carriage 5 according to the first embodiment is provided with a first roller 12a, a second roller 12b, and a third roller 12c. The first roller 12a is arranged in contact with the first side running surface 10a and the second roller 12b and third roller 12c are arranged in contact with the second side running surface 10b. This way the carriage 5 can be supported by the guide 3 even when an a-symmetrical load acts on the carriage 5 through the rollers 12a, 12b, 12c. An a-symmetrical load is a load which acts outside a centre of gravity of the guide 3, resulting in forces and moments of forces that must safely be distributed over the rollers 12a, 12b, 12c.

Shown in FIG. 3, the first roller 12a comprises a lower auxiliary first roller tyre 13a, a first roller upper tyre 18a and a first roller spindle 14a having a rotational axis 15a. The first roller spindle 14a rotates around the first roller rotational axis 15a. The lower auxiliary first roller tyre 13a and the first roller upper tyre 18a are arranged on the first roller spindle 14a. The lower auxiliary first roller tyre 13a and the first roller upper tyre 18a therefore rotate around the first roller rotational axis 15a. The first roller upper tyre 18a is provided with an peripheral friction surface which is in frictional engagement with the first side running surface 10a. By driving the first roller spindle 14a the first roller 12a can be driven by friction. This contributes to a transportation of the carriage with respect to the guide 3.

The lower auxiliary first roller tyre 13a is also in contact with the first side running surface 10a. The lower auxiliary first roller tyre 13a has the same rotational axis 15a as the first roller upper tyre 18a. The lower auxiliary first roller tyre 13a is arranged on the first roller spindle 14a. The lower auxiliary first roller tyre 13a has a smooth peripheral friction surface.

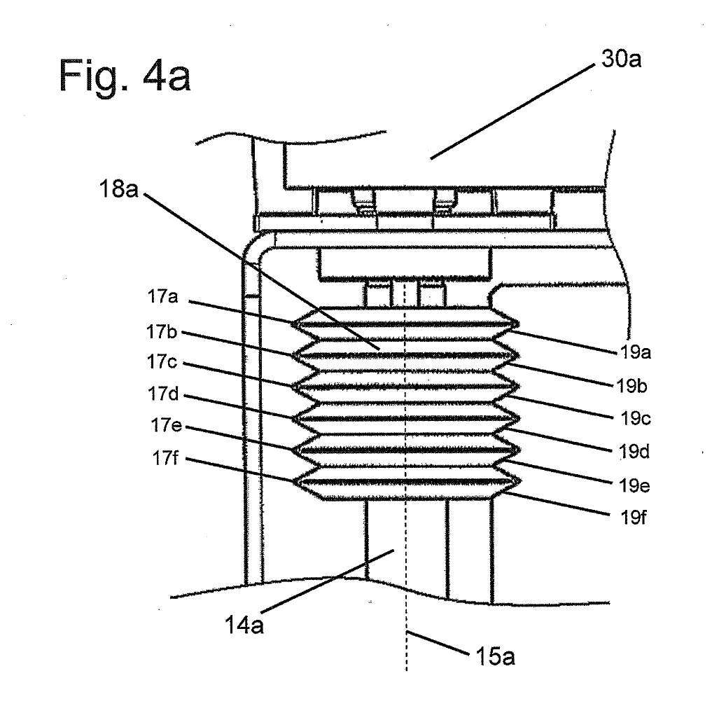

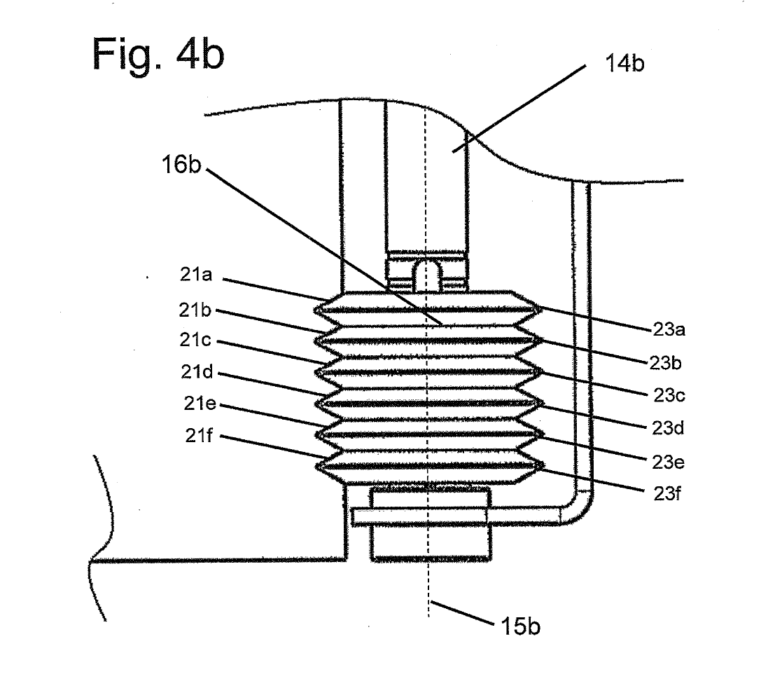

The first roller upper tyre 18a is in frictional engagement with the first side running surface 10a of the guide 3. The first roller upper tyre 18a is provided with a plurality of upper first roller members 17. The plurality of upper first roller members comprise six separate upper first roller members 17a, 17b, 17c, 17d, 17e, 17f, shown in FIG. 4a. The upper first roller members of the plurality of upper first roller members 17 are each arranged in parallel planes each perpendicular to the first roller rotational axis 15a and have a point shape in the form of a ̂ at their outer end. The plurality of upper first roller members 17 increases its peripheral friction surface.

The first side running surface 10a is provided with a plurality of first side running surface members 19. The plurality of first side running surfaces comprises six separate first side running surface members 19a, 19b, 19c, 19d, 19e, 19f, best shown in FIG. 4a and have a V-shape at their inner end for receiving the plurality of upper first roller members 17. The first side running surface members of the plurality of first side running surface members 19 are each arranged in parallel planes each perpendicular to the first roller rotational axis 15a and are complementary to the plurality of upper first roller members 17. The plurality of upper first roller members 17 fits complementary and is received in the plurality of first side running surface members 19. This has as result that support of the carriage 5 by the guide 3 is increased. The upper first roller peripheral friction surface is larger due to providing the peripheral friction surface with the upper first roller members 17a, 17b, 17c, 17d, 17e, 17f. The first roller upper tyre 18a provides an undulated first roller peripheral friction surface which is received in a complementary undulated first side running surface 10a. The peripheral friction surface of the plurality of upper first roller members 17 as well as the complementary first side running surface 10a are increased. Therefore, more friction between the guide 3 and the carriage 5 can be provided resulting in a more efficient transportation by means of friction.

Shown in FIG. 2 and FIG. 3, the second roller 12b is provided to the carriage 5 and comprises a second roller lower tyre 16b, an upper auxiliary second roller tyre 13b and a second roller spindle 14b having a rotational axis 15b. The second roller spindle 14b rotates around the second roller rotational axis 15b. The upper auxiliary second roller tyre 13b and the second roller lower tyre 16b are arranged on the second roller spindle 14b. The upper auxiliary second roller tyre 13b and the second roller lower tyre 16b therefore rotate around the second roller rotational axis 15b. The second roller lower tyre 16b is provided with a peripheral friction surface which is in frictional engagement with the second side running surface 10b of the guide 3. By driving the second roller spindle 14b the second roller 12b can be driven by friction. This contributes to a transportation of the carriage 5 with respect to the guide 3.

The upper auxiliary second roller tyre 13b is also in contact with the second side running surface 10b. The upper auxiliary second roller tyre 13b has the same rotational axis 15b as the second roller lower tyre 16b. The upper auxiliary second roller tyre 13b has a smooth peripheral friction surface. The second roller 12b is arranged in contact with an opposing side of the first side running surface 10a, namely the second side running surface 10b. This allows for exerting forces by the first roller 12a and second roller 12b on the guide 3 in opposing directions.

FIG. 2, shows the second side running surface 10b. The second side running surface 10b comprises a plurality of second side running surface members 21 seen FIG. 4b. The second side running surface members 21a, 21b, 21c, 21d, 21e, 21f are arranged longitudinal along the guide 3.

The second roller lower tyre 16b is in frictional engagement with the second side running surface 10b. The second roller lower tyre 16b comprises lower second roller members 23a, 23b, 23c, 23d, 23e, 23f which are arranged in parallel planes each perpendicular to the second roller rotational axis 15b and have a point shape in the form of a ̂ at their outer end. The second roller lower tyre 16b is received in the second side running surface 10b due to their complementary fitting supporting members. This allows for further support of the carriage 5 by the guide 3 in a gravitational direction.

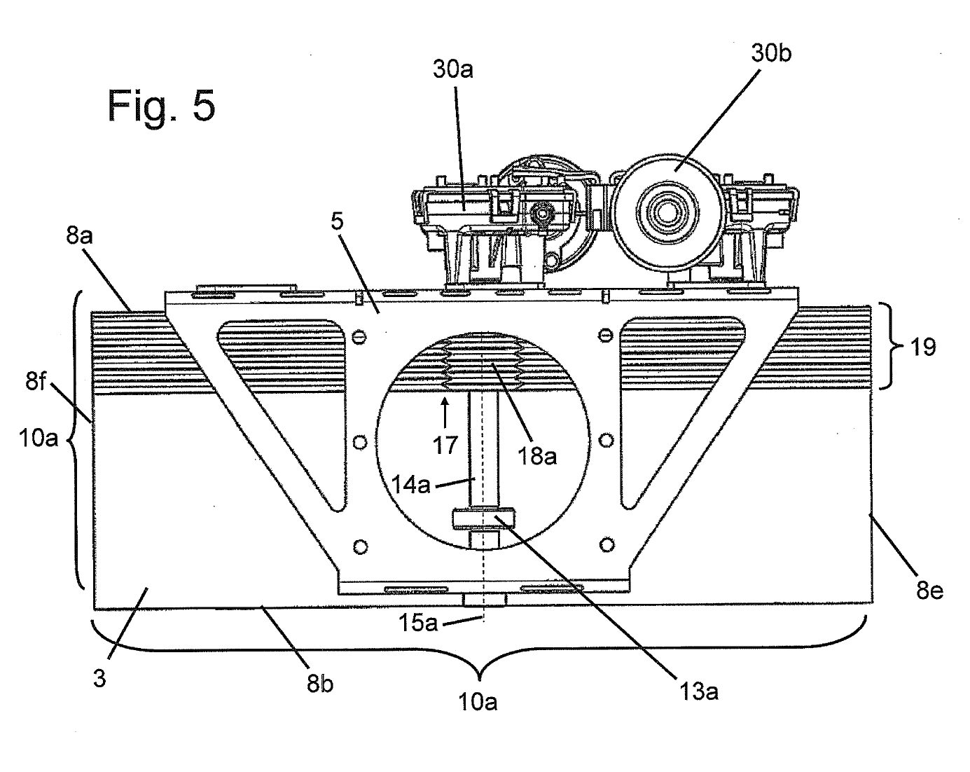

FIG. 2 and FIG. 5 show a third roller 12c comprising a third roller lower tyre 16c, an upper auxiliary third roller tyre 13c and a third roller spindle 14c having a third roller rotational axis 15c. The third roller 12c is similarly arranged as the second roller 12b. The second roller 12b is arranged in contact with the second side running surface 10b. This results in that the carriage 5 is unable to rotate with respect to the guide 3 when a moment of force is exerted on the carriage 5. An arrangement of three rollers 12a, 12b, 12c arranged in contact with the guide allows for a stable carriage 5.

The third roller lower tyre 16c comprises a plurality of lower third roller members 25 comprising six separate lower third roller members 25a, 25b, 25c, 25d, 25e, 25f which are received and supported by the second side running surface members 21a, 21b, 21c, 21d, 21e, 21f of the second side running surface 10b. The second roller 12b and third roller 12c therefore complementary fit with the same second side running surface members 21a, 21b, 21c, 21d, 21e, 21f by means of the second roller lower tyre 16b and third roller lower tyre 16c respectively. This allows for further support of the carriage 5 by the guide 3 in the gravitational direction.

The second roller 12b and third roller 12c are in a frictional engagement with the second side running surface 10b of the guide 3. Similar to the first roller 12a and second roller 12b, the upper auxiliary third roller tyre 13c and the third roller lower tyre 16c are arranged on the third roller spindle 14c. The upper auxiliary third roller tyre 13c and the third roller lower tyre 16c therefore rotate around the third roller rotational axis 15c. Driving the third roller 12c contributes to transporting the carriage 5 with respect to the guide 3.

FIG. 2 further shows that the carriage 5 comprises a first drive 30a for driving the first roller 12a, a second drive 30b for driving the second roller 12b and a third drive 30c for driving the third roller 12c. The drives 30a, 30b, 30c drive the respective rollers 12a, 12b, 12c such that the carriage 5 can be transported along the guide 3. The drives 30a, 30b, 30c are in a driveable connection with the respective spindles 14a, 14b, 14c of the respective rollers 12a, 12b, 12c.

By driving the respective rollers 12a, 12b, 12c, the first roller upper tyre 18a, the second roller lower tyre 16b and third roller lower tyre 16c are driven and rotating as well. The respective tyres 18a, 16b and 16c are in a frictional engagement with the respective running surfaces 10a, 10b and drive the carriage by means of friction. As the respective tyres are provided with respective roller members their respective roller peripheral friction surface is increased as the respective roller members are received in the respective fitting complementary side running surface members of the respective running surfaces 10a, 10b.

Similarly, the lower auxiliary first roller tyre 13a, upper auxiliary second roller tyre 13b and upper auxiliary third roller tyre 13c are driven by the respective drives 30a, 30b, 30c. These auxiliary tyres have a smooth peripheral friction surface and may contribute less compared to the rollers provided with roller members. However, by driving the auxiliary tyres 13a, 13b 13c a more efficient and stable transport of the carriage may be acquired.

FIG. 3 shows the stair lift form a front view showing the first end 8e. The first roller upper tyre 18a in frictional engagement with the first side running surface 10a is arranged higher than the second roller lower tyre 16b in frictional engagement with the second side running surface 10b. Seen in FIG. 1, the load carrier 7 extends outwards from the second side running surface 10b away from the first side running surface 10a. This arrangement of the load carrier 7 results in a moment of force. The fact that the first roller upper tyre 18a is arranged higher than the second roller lower tyre 16b results in that the moment of force pushes the second roller lower tyre 16b towards the second side running surface 10b and the first roller upper tyre 18a towards the first side running surface 10a, thus increasing the frictional engagement. This has as advantage that this provides a passive safety arrangement against wearing as the first roller upper tyre 18a and the second roller lower tyre 16b are pushed into the respective side running surface 10a, 10b even when their roller members 17, 23 wear. Similarly, better seen in FIG. 2 the moment of force pushes the third roller lower tyre 16c towards the second side running surface 10b, increasing the frictional engagement.

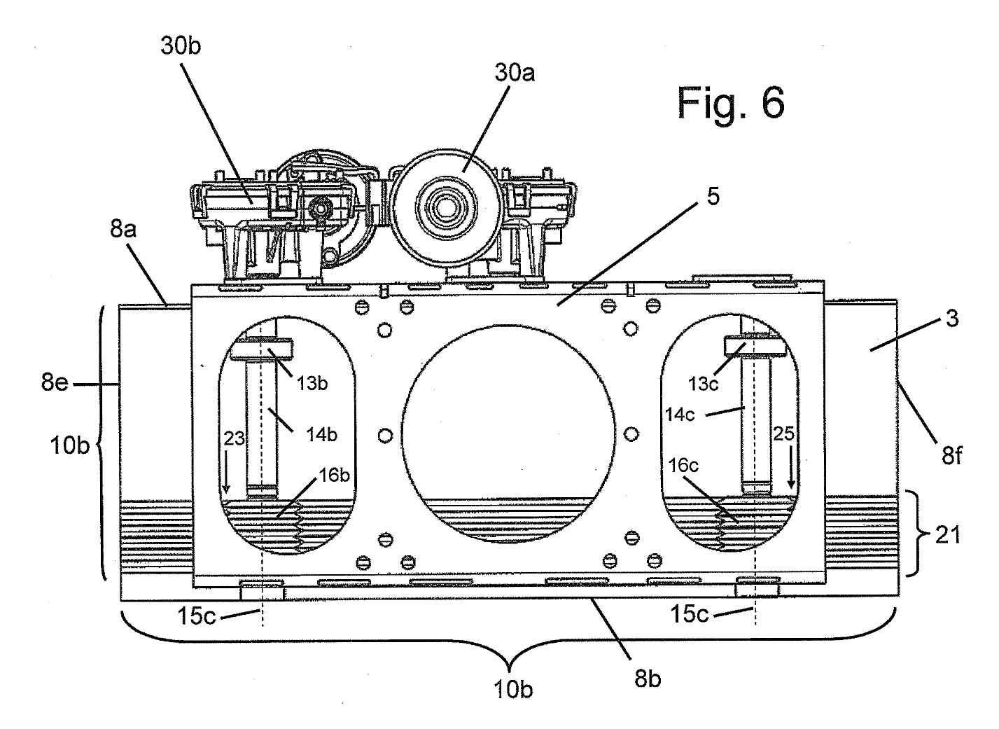

FIG. 5 and FIG. 6 show respectively the first side running surface 10a and the second side running surface 10b of the guide 3 and the corresponding carriage 5 and rollers. These figures give an overview of the arrangement of the rollers 12a, 12b, 12c with respect to each other and how the moment of force due resulting from the load carrier 7a are distributed over the rollers 12a, 12b, 12c.

In the perspective of FIG. 5, the second end 8f is shown at the left of the guide 3. The first end 8e is shown at the right of the guide 3. The first side running surface 10a is provided with the plurality of first side running surface members 19 above the centre of gravity of the guide 3. In particular, the plurality of first side running surface members 19 is arranged above the middle between the topside 8a and the downside 8b. The plurality of upper first roller members 17 of the first roller upper tyre 18a and the smooth peripheral surface of the lower auxiliary first roller tyre 13a are in frictional engagement with the first side running surface 10a. The plurality of upper first roller members 17 of the first roller upper tyre 18a is received and supported by the plurality of first side running surface members 19 of the first side running surface 10a. Having the first roller upper tyre 18a arranged above the lower auxiliary first roller tyre 13a results in that the first roller upper tyre 18a is pressed towards the guide 3. Having the first roller upper tyre 18a arranged above the lower auxiliary first roller tyre 13a with the centre of gravity of the guide 3 in between results in a relatively compact guide 3 which may be placed along the staircase more conveniently.

In the perspective of FIG. 6, the first end 8e is shown at the left of the guide 3. The second end 8f is shown at the right of the guide 3. The second side running surface 10b is provided with the plurality of second side running surface members 21 below the centre of gravity of the guide 5. In particular, the plurality of second side running surface members 21 is arranged below the middle between the topside 8a and the downside 8b. The plurality of lower second roller members 23 of the second roller lower tyre 16b and the smooth peripheral surface of the upper auxiliary second roller tyre 13b are in frictional engagement with the second side running surface 10b. Again, due to the moment of force the second roller lower tyre 16b is pressed towards the guide 3 resulting in more friction. Having the second roller lower tyre 16b arranged below the upper auxiliary second roller tyre 13b with the centre of gravity of the guide 3 in between results in a relatively compact guide 3 which may be placed along the staircase more conveniently.

The plurality of lower third roller members 23 and the smooth peripheral surface of the upper auxiliary third roller tyre 13c are in frictional engagement with the second side running surface 10b. The plurality of lower second roller members 23 and the plurality of lower third roller members 23 are received and supported by the plurality of second side running surface members 21 of the second side running surface 10b. Again, due to the moment of force the third roller lower tyre 16c is pressed towards the guide 3 resulting in more friction. Having the third roller lower tyre 16c arranged below the upper auxiliary third roller tyre 13c with the centre of gravity of the guide 3 in between results in a relatively compact guide 3 which may be placed along the staircase more conveniently.

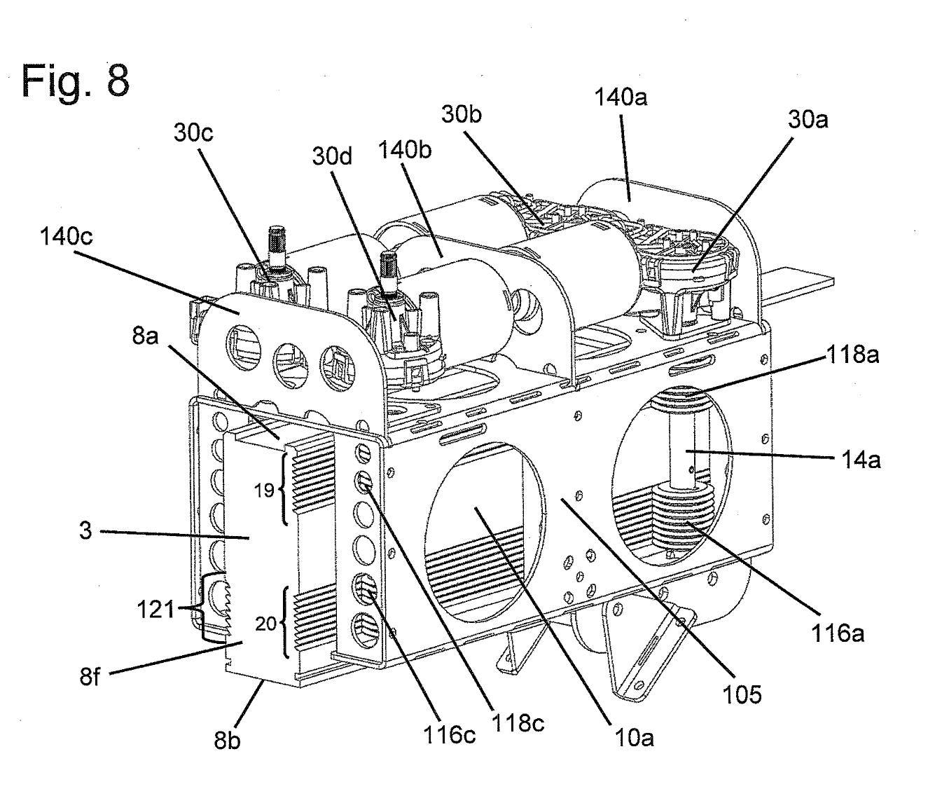

FIG. 1, 7-12 show a stair lift 101 according to a second embodiment. This stair lift 101 comprises components that are similar to the stair lift 1 according to the first embodiment. Similar components are denoted with the same numerals as in FIG. 1 to FIG. 6. The stair lift 101 comprises a guide 3 and a carriage 5 having a load carrier 7 as shown in FIG. 1. The load carrier 7 can be transported over the guide 3 from a start point A to an end point B or vice versa. The carriage 5 further comprises a frame 105. The frame 105 can be seen best in FIG. 8. The frame 105 provides stiffness to the carriage 5 and ensures that a load exerted on the load carrier 7 is safely transferred to the guide 3. The guide 3 defines six sides, being a topside 8a, a downside 8b, a first side surface 8c, a second side surface 8d, a first end 8e and a second end 8f. The sides are longitudinal with the first end 8e corresponding to the start point A and the second end 8f corresponding to the end point B. The guide 3 is arranged to a staircase 6. The start point A is arranged at a lower point of the staircase 6. The end point B is arranged at an upper point of the staircase 6. Therefore, the guide 3 is inclined with respect to a ground C which is a horizontal plane. This way the load can be transported along the staircase.

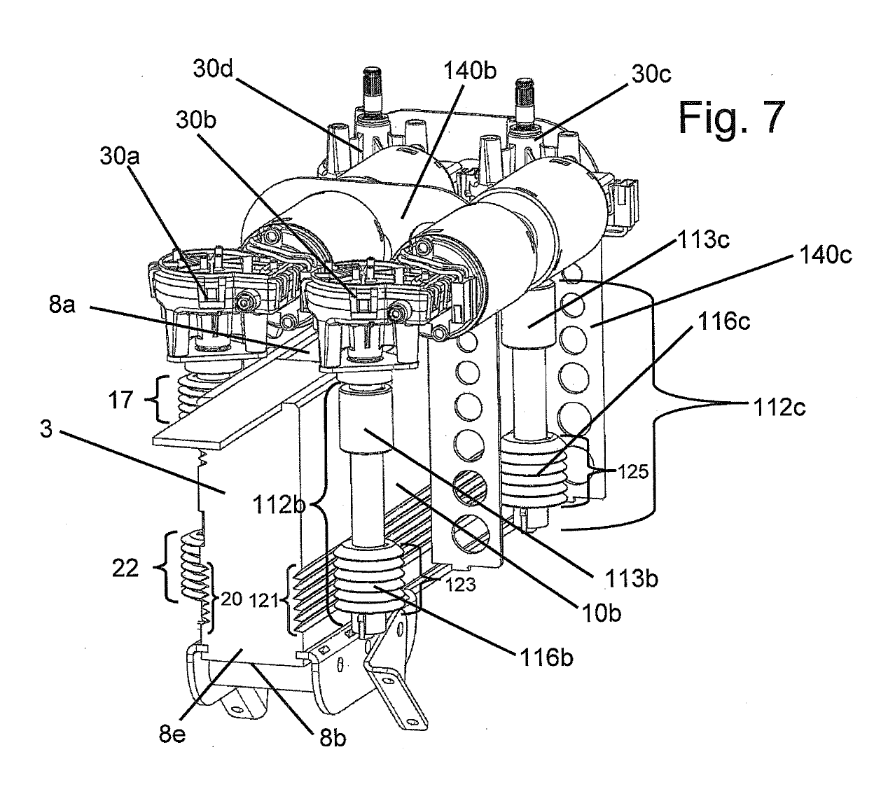

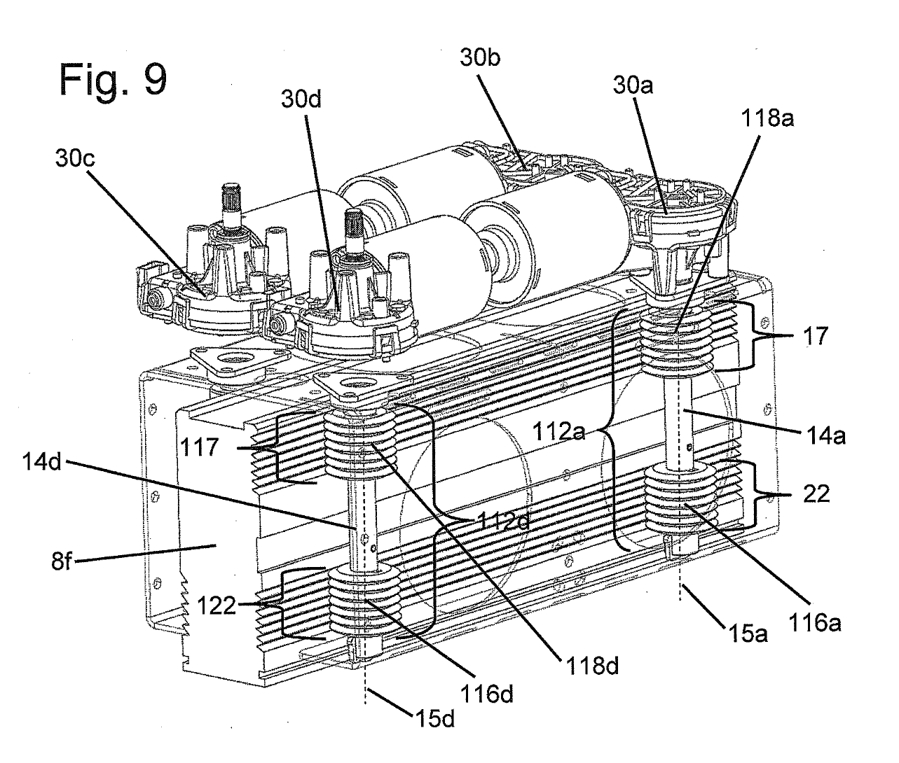

The first side surface 8c comprises a first side running surface 10a and the second side surface 8d comprises a second side running surface 10b. FIG. 7 shows a perspective view showing the first end 8e and the second side running surface 10b. FIG. 8 and FIG. 9 show a perspective view showing the second end 8f and the first side running surface 10a. The first side running surface 10a and the second side running surface 10b are suitable for being in contact with rollers provided to the frame 105. The rollers are for example wheels having a rotational axis.

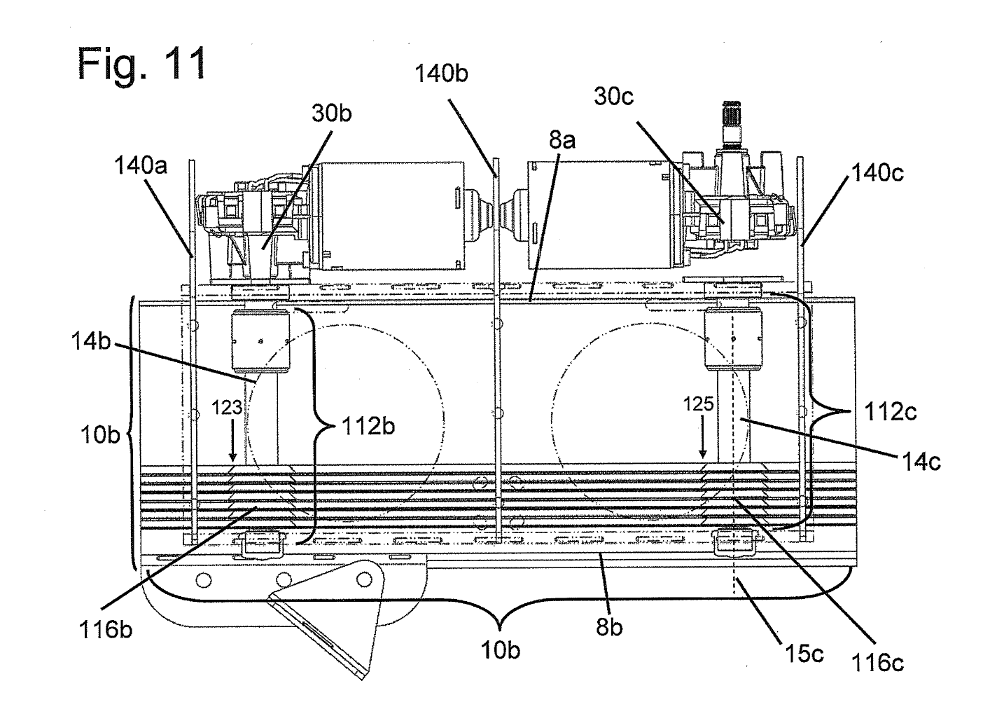

In this second embodiment the frame 105 is provided with four rollers. Two rollers, being a first roller 112a and a fourth roller 112d, are arranged in frictional engagement with the first side running surface 10a. This can be seen best in FIG. 9. Two other rollers, being a second roller 112b and a third roller 112c are arranged in frictional engagement with the second side running surface 10b. These can be seen best in FIG. 11. Note, that the first side running surface 10a and the second side running surface 10b are opposing sides. Therefore, the first roller 112a and the fourth roller 112d are arranged on opposing sides with respect to the second roller 112b and the third roller 112d. The fact that four rollers are arranged with two rollers on opposing sides has as advantage that forces and moments of forces originated by the load carrier 7 can be distributed safely via the rollers 112a, 112b, 112c, 112d to the guide 3 which will be explained below.

The load carrier 7 is substantially parallel to the ground C, as can be seen in FIG. 1. The load carrier 7 extends outwards from the second side running surface 10b away from the first side running surface 10a. Loading the load carrier 7 combined with the fact that the guide 3 is inclined with respect to the ground C results in an a-symmetrical load. An a-symmetrical load is a load which acts outside a centre of gravity of the guide 3, resulting in forces and moment of forces that must safely be distributed over the rollers 112a, 112b, 112c, 112d.

Therefore, the first roller 112a and the fourth roller 112d, being in contact with the first side running surface 10a, are spaced with respect to each other along a longitudinal direction of the guide 3. This can be seen best in FIG. 9. The second roller 112b and the third roller 112c, being in contact with the second side running surface 10b are also spaced with respect to each other along the longitudinal direction of the guide 3. This can be seen best in FIG. 7. This ensures that a second moment of force around an axis parallel to a gravitational direction is distributed towards the second roller 112b and fourth roller 112d, pressing these rollers 112b, 112d towards the guide 3 increasing frictional engagement. This second moment of force is generated as a result of the a-symmetrical load. The gravitational direction lies perpendicular to the ground C. Having four rollers 112a, 112b, 112c, 112d, in particular two spaced rollers at opposing side running surfaces 10a, 10b, has as advantage that a distance between a roller at the first side running surface 10a and a roller at the second side running surface 10b can be larger compared with three rollers such as in the first embodiment. A larger distance between a roller at the first side running surface 10a and a roller at the second side running surface 10b results in a smaller force distributed by the second moment of force. By increasing the distance the second moment of force results in less pressing of respective rollers towards the guide 3. A more balanced distribution of forces may be acquired. Moreover, the carriage 5 can still be compact.

Furthermore the rollers 112a, 112b, 112c, 112d are each arranged with an upper tyre 118a, 113b, 113c, 118d and a lower tyre 116a, 116b, 116c, 116d that are in contact with the side running surfaces 10a, 10b. Each roller 112a, 112b, 112c, 112d further comprises a roller spindle 14a, 14b, 14c, 14d having a rotational axis 15a, 15b, 15c, 15d. The upper tyre 118a, 113b, 113c, 118d is spaced with respect to the lower tyre 116a, 116b, 116c, 116d along the respective rotational axis. The lower tyres 116a, 116b, 116c, 116d are arranged near a lower end of the respective roller spindles 14a, 14b, 14c, 14d. The upper tyres 118a, 113b, 118c, 113d are arranged near an upper end of the respective roller spindles 14a, 14b, 14c, 14d. This allows for a distribution of a first moment of force around an axis parallel to the longitudinal direction of the guide 3. This first moment of force, generated as a result of the a-symmetrical load, is distributed towards the first roller upper tyre 118a, the fourth roller upper tyre 118d, the second roller lower tyre 116b and the third roller lower tyre 116c.

The frame 105 is further arranged with four motors which drive the rollers 112a, 112b, 112c, 112d by rotating their roller spindles 14a, 14b, 14c, 14d. The first roller 112a is driven by a first motor 30a. The second roller 112b is driven by a second motor 30b. The third roller 112c is driven by a third motor 30c and the fourth roller 112d is driven by a fourth motor 30d. By driving the rollers 112a, 112b, 112c, 112d the carriage 5 can be transported along the guide 3 by means of friction between the rollers 112a, 112b, 112c, 112d and the side running surfaces 10a, 10b. By driving each roller 112a, 112b, 122c, 112d with a separate motor 30a, 30b, 30c, 30d sufficient power may be generated to transport the carriage 5 along the guide 3.

The first roller lower tyre 116a, first roller upper tyre 118a, fourth roller lower tyre 116d and fourth roller upper tyre 118d comprise each a plurality of roller members 22, 17, 122, 117. Complementary, the first side running surface 10a comprises a plurality of upper first side running surface members 19 and a plurality of lower first side running surface members 20. The first roller lower tyre 116a and the fourth roller lower tyre 116d are arranged such that their respective pluralities of roller members 22, 122 are received by and aligned with the lower first side running surface members 20. The first roller upper tyre 118a and the fourth roller upper tyre 118d are arranged such that their respective pluralities of roller members 17, 117 are received by and aligned with the upper first side running surface members 19. The plurality of first side running surface members 19, 20 fit complementary with the pluralities of roller members 22, 17, 122, 117 which has as result that support in a gravitational direction of the carriage 5 and frame 105 by the guide 3 is increased.

At an opposing surface, being the second side running surface 10b, a plurality of second side running surface members 121 is provided. The second roller lower tyre 116b and third roller lower tyre 116c comprise each complementary plurality of roller members 123, 125. This means that the second roller lower tyre 116b and third roller lower tyre 116c are arranged such that they are received by and aligned with the plurality of second side running surface members 121. The plurality of second side running surface members 121 therefore fit complementary with the plurality of roller members 123 of the second roller lower tyre 116b and the plurality of roller members 125 of the third roller lower tyre 116c which has as result that support in a gravitational direction of the carriage 5 and frame 105 by the guide 3 is increased. This allows the carriage 5 to rest on the guide 3 in combination with the first roller tyres 116a, 118a and the fourth roller tyres 116d, 118d.

The second roller upper tyre 113b and the third roller upper tyre 113c are auxiliary tyres and have a smooth peripheral friction surface. Although they are in frictional engagement with the guide 3 their contribution to drive the carriage 5 may be less than the other tyres which are provided with the pluralities of roller members. The auxiliary second roller upper tyre 113b and auxiliary third roller upper tyre 113c are cylindrical. Their peripheral outer surface can be increased by increasing a length of the cylinder in a direction parallel to their respective roller axes 15b, 15c.

The pluralities of roller members 22, 17, 122, 117 of the first roller lower tyre 116a, first roller upper tyre 118a, fourth roller lower tyre 116d and fourth roller upper tyre 118d are shaped similar to the ones in the first embodiment. These pluralities of roller members 22, 17, 122, 117 are arranged in parallel planes each perpendicular to the respective rotational axis 15a, 15d of the roller 112a, 112d and have a point shape in the form of a ̂ at their outer end.

The pluralities of roller members 123, 125 of the second roller lower tyre 116b and the third roller lower tyre 116c also have a point shape in the form of a ̂ at their outer end. However, the pluralities of roller members 123, 125 of the second roller lower tyre 116b and third roller lower tyre 116c are shaped differently inwards from their outer end. This is advantageous as each roller tyre is distributed with a different load due to the a-symmetrical loading of the stair lift 1. By shaping the roller members differently each roller member can exert and optimal force on the guide 3.

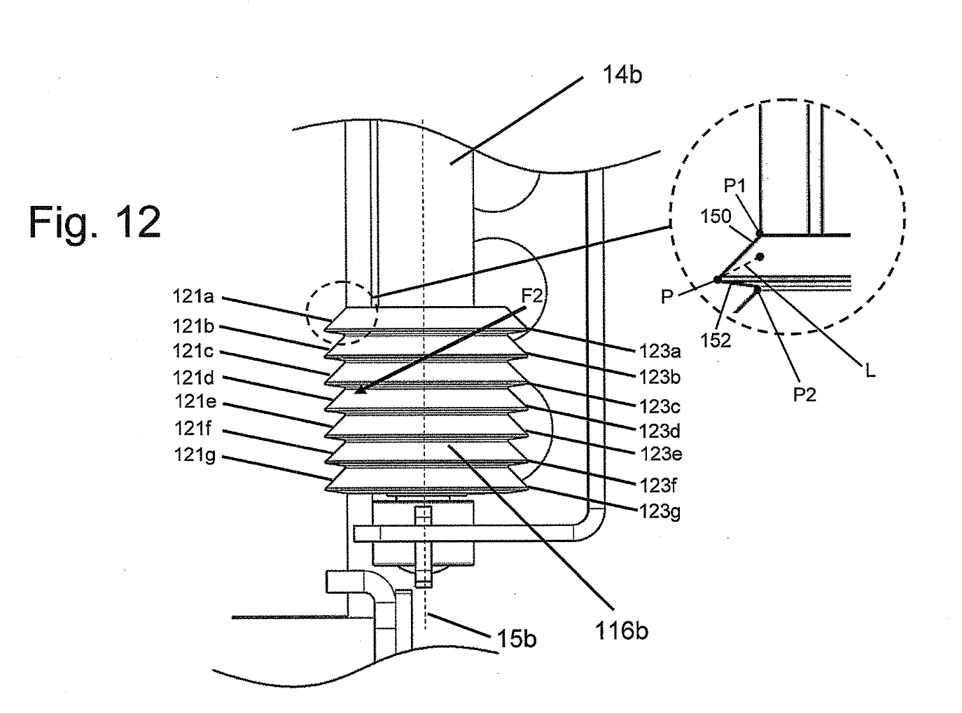

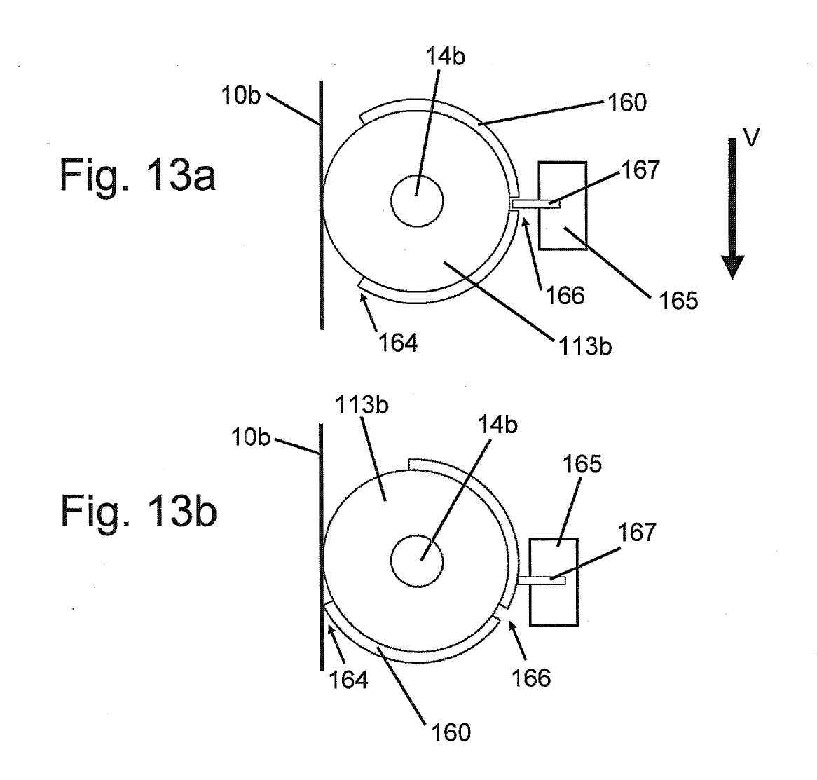

This is explained for the plurality of roller member 123 of the second roller lower tyre 116b as shown in FIG. 12. FIG. 12 shows each member of the second side running surface members 121a, 121b, 121c, 121d, 121e, 121f, 121g. Here, the plurality of second side running surface members 21 comprise seven individual members. Also shown, is the second roller lower tyre 116b comprising the plurality of second roller members 123. The plurality of second roller members 123 is complementary and in frictional engagement with the plurality of second side running surface members 121. Each member of the second roller members 123a, 123b, 123c, 123d, 123e, 123f, 123g is shown. Now, the shape of a member of the second roller members 123a, 123b, 123c, 123d, 123e, 123f, 123f shall be described in more detail.

This will be done by describing an upper second roller member 123a. As can be seen in FIG. 12, the upper second roller member 123a is highlighted and shown in more detail at a location where it is in frictional engagement with an upper second side running surface member 121a. Note that, the description of the shape particularly also applies for the shape of the roller members of the second roller lower tyre 116b and third roller lower tyre 116c.

The upper second roller member 123a is a flange having a peripheral outer line. The peripheral outer line is circular and is partly in frictional engagement with the upper second side running surface member 121a at a point P. In other words, the point P is a location where the peripheral outer line of the upper second roller member 123a is in frictional engagement with the upper second side running surface member 121a. The upper second roller member 123a extends from a peripheral surface to the point P located away from the second roller rotational axis 15b. An upper member side surface 150 and a lower member side surface 152 originate from the peripheral surface of the second roller lower tyre 116b and extend away from the second roller rotational axis 15b where they form the peripheral outer line including point P. The upper member side surface 150 originates from the peripheral surface at an upper member side surface origin P1 and the lower member side surface 152 originates from the peripheral surface at a lower member side surface origin P2 as can be seen in a cross section according to FIG. 12. This cross section is in a plane comprising the second roller rotational axis 15b and the point P. A location of the point P is such that a virtual line L between the point P and the middle of the upper member side surface origin P1 and the lower member side surface origin P2 is substantially aligned with a direction of a second roller lower tyre force F2. The second roller lower tyre force F2 is the force that the second roller 112b exerts on the second side running surface 10b of the guide 3. This has as advantage that the upper member side surface 150 and the lower member side surface 152 generate an optimal friction with the complementary upper second side running surface member 121a as the virtual line L runs substantially through their middle generating a same amount of friction to the member side surfaces 150, 152.

The direction of the second roller lower tyre force F2 as shown in FIG. 12 results from the a-symmetrical load. In particular, the second roller lower tyre force F2 is a combination of the first moment of force around an axis parallel to the longitudinal direction of the guide 3 and the gravitational force. In the view of FIG. 12A a direction of the gravitational force is downwards. The first moment of force results in a force pressing the second roller lower tyre 116b towards the guide 3. Therefore, in the view of FIG. 12 the direction of the second roller lower tyre force F2 is downwards and to the left. 12. The corresponding virtual line L is aligned along this direction of the second roller lower tyre force F2.

This results in that an upper member side surface angle between the upper member side surface 150 and an auxiliary plane perpendicular to the second roller rotational axis 15b is larger than a lower member side surface angle between the lower member side surface 152 and the auxiliary plane.

This has as further advantage that it results in a better support in the gravitational direction as the lower member side surface 152 is less oblique to the gravitational direction compared to the upper member side surface 150 such that the carriage 5 is better supported by the guide 3. Less oblique in this context means nearer to a perpendicular arrangement.

In this particular second embodiment, this results in that the lower member side surface 152 lies in a plane substantially perpendicular to the second roller rotational axis 15b as can be seen in FIG. 12.

A shape of the other roller members may be determined in a similar way. In this second embodiment the roller members of the first roller lower tyre 116a, first roller upper tyre 118a, fourth roller lower tyre 116d and fourth roller upper tyre 118d, which are located at the opposite first side running surface 10a, are pressed substantially horizontal towards the guide 3.

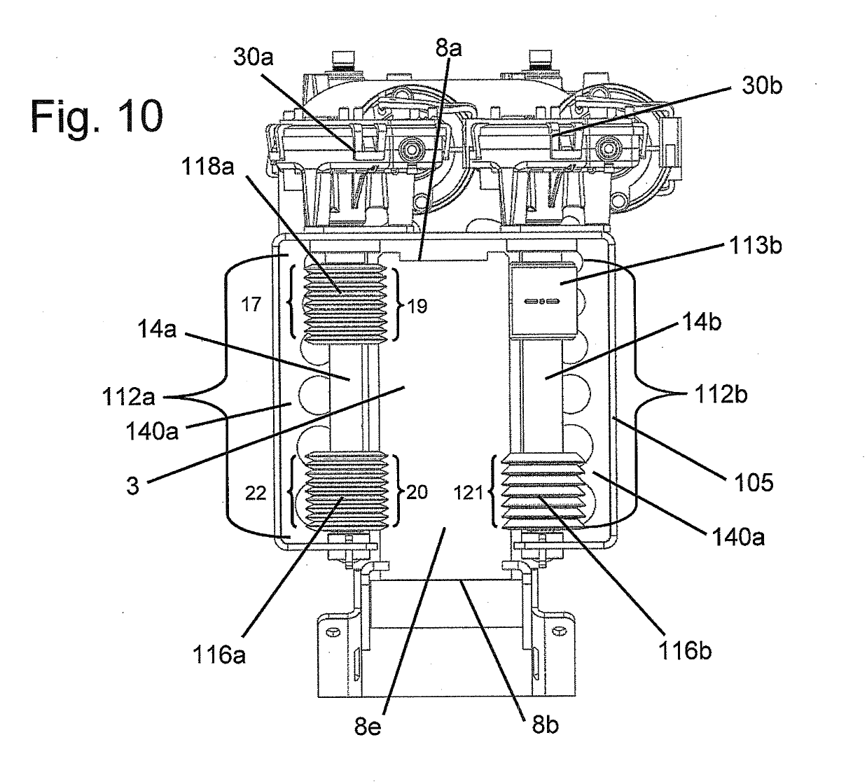

Therefore, the pluralities of roller members 22, 17, 122, 117 of the first roller lower tyre 116a, first roller upper tyre 118a, fourth roller lower tyre 116d and fourth roller upper tyre 118d have a virtual line (not shown) between a point and the middle of a respective upper member side surface origin and lower member side surface origin substantially in a plane perpendicular to the respective rotational axis 15a, 15d. The first roller lower tyre 116a and first roller upper tyre with their corresponding pluralities of roller members 22, 17 can be seen in FIG. 10. FIG. 10 shows a side view of the stair lift 101. It is a frontal view with respect to the first end 8e and further clearly shows the first roller 112a but also the second roller 112b.

FIG. 9 provides a good view of the first roller 112a and the fourth roller 112d. The lower first roller tyre 116a and upper first roller tyre 118a are arranged as floating tyres with respect to the first roller spindle 14a. The lower fourth roller tyre 116d and upper fourth roller tyre 118d are arranged as floating tyres with respect to the fourth roller spindle 14d. This means that the lower first roller tyre 116a and the upper first roller tyre 118a can move with respect to the first roller spindle 14a along the first roller rotational axis 15a. Also the lower fourth roller tyre 116d and the upper fourth roller tyre 118d can move with respect to the fourth roller spindle 14d along the fourth roller rotational axis 15d. This has as advantage that an optimal friction between the floating tyres and the guide is available for transporting the carriage 5 along the guide 3, even when due to the a-symmetric load the frame 105 at the first side running surface 10b is moved upwards. Note, that the lower second roller tyre 116b and the lower third roller tyre 116c are not floating. These rollers are provided at the opposing second side running surface 10b and contribute to the carrying of the carriage 5 by the guide 3. Due to the a-symmetric load the lower second roller tyre 116b and the lower third roller tyre 116c exert a highest force on the guide 3. Therefore, it is optimal to provide these rollers as fixed along a direction of the respective longitudinal axis.

An amount of movement of the floating tyres can be limitless, meaning that the floating tyres are free to move along the respective rotational axis. Alternatively, the movement of the floating tyres are limited to a certain predetermined amount.

The second embodiment further comprises a pre-stressed frame 105 acting as a passive roller pressing means best seen in FIG. 11. Although, the pre-stressed frame 105, being part of the carriage 5, is described for the second embodiment, the pre-stressed frame 105 is also foreseen to be applied in combination with other embodiment, e.g. the first embodiment. Also, the pre-stressed frame 105, can be applied in other stair lifts driven by friction, e.g. state of art stair lifts. FIG. 11 shows that the frame 105 comprises a front frame rib 140a, a middle frame rib 140b and an end frame rib 140c. The frame ribs 140a, 140b, 140c are substantially fl-shaped (inverse U-shape) having their legs at a lower end of the frame 105. A top of the frame ribs 140a is arranged at an upper end of the frame 105. Shown best in FIG. 8 the frame ribs 140a, 140b, 140c are arranged as plates parallel to each other. The frame ribs 140a, 140b, 140c provide structural integrity to the frame 105. The frame 105 is pre-stressed such that the frame 105 presses the rollers towards the guide 3. As shown in FIG. 8, the frame 105 is pre-stressed by means of the frame ribs 140a, 140b, 140c. The legs of each frame rib 140a, 140b, 140c extend towards each other or in other words a distance between leg outer ends of a single frame rib 140a, 140b, 140c is slightly smaller than a distance between leg roots, of the legs of the single frame rib 140a, 140b, 140c. The rollers 112a, 112b, 112c, 112d are arranged to the frame 105 with their rotational axes 15a, 15b, 15c, 15d substantially parallel to a length of the legs. This results in that particularly the lower rollers 116a, 116b, 116c, 116d are pressed towards the side running surfaces 10a, 10b. This increases friction between the rollers 112a, 112b, 112c, 112d and the guide 3. A further advantage is that it may increase safety and redundancy as after wearing of the roller members 22, 17, 122, 117, 123, 125, the rollers 112a, 112b, 112c, 112d and thus the roller members 22, 17, 122, 117, 123, 125 are pressed towards the guide 3. A further advantage is that the stair lift 105 may be free from active roller pressure means, for example spring actuated counter rollers. At least the pre-stressed frame 105 is more redundant to wearing of the rollers 112a, 112b, 112c, 112d. In a further preference, the difference between the distance between the legs outer ends of the single frame rib 140a, 140b, 140c and the distance between the leg roots of the single frame rib 140a, 140b, 140c is smaller than 3 mm, more particular 2 mm, preferably 1.5 mm.

Preferably, as can be seen in FIG. 7 and FIG. 10, the frame ribs 140a, 140b, 140c comprise multiple circular recesses located in the legs of the frame ribs 140a, 140b, 140c and provide a variable stiffness in the legs of the frame ribs 140a, 140b, 140c depending on a loading of the carriage 5. Stresses in the frame ribs 140a, 140b, 140c resulting from the a-symmetrical load, in particular the first moment of force around an axis parallel to a longitudinal direction of the guide 3, are distributed along the length of the leg. The distributed stresses vary along the length of the leg. More stress occurs near the leg roots and less stress occurs near the leg outer end due to the loading. The circular recess are spaced along the length of the leg and have varying diameters that are representative to the distributed stresses that vary along the length of the leg. In particular, a circular recess located near a leg root has a smaller diameter than a circular recess located near the leg root. A smaller circular recess means more material at that particular location for absorbing the stress. Note that, more material results in more stiffness. A larger circular recess means less material at that particular location for absorbing the stress. Note that, less material results in less stiffness. Therefore, the diameter of each circular recess increases from the leg root towards the leg outer end such that sufficient material is present to absorb the distributed stresses due to the a-symmetrical load. Preferably, 7 circular recesses are arranged in one leg. Advantage is that by having frame ribs 140a, 140b, 140c comprising a stiffness varying arrangement, a more optimal absorption of the stresses by the frame 105 can be acquired. A further advantage is that weight can be saved while sufficient stiffness is provided to the frame 105.

In a further preference, the circular recesses are arranged outwards from a middle of the legs. The middle of a leg is between an inner side of the leg facing the guide 3 and an opposite outer side. Arranged outwards from the middle of the legs meaning arranged closer to the outer side than to the inner side. Near the outer side of the legs, less stiffness is needed as this is the side where the legs are connected with a plate perpendicularly arranged with respect to the frame ribs 140a, 140b, 140c as can be seen in FIG. 8. The fact that the outer side of the legs are connected with the plate, results in more material at that side. This results in that more stiffness is provided near the outer side of the legs, therefore allowing the circular recesses to be larger near the outer side of the legs while still providing sufficient stiffness.

FIG. 13a and FIG. 13b show a safety mechanism. The safety mechanism is shown for one roller, being the upper auxiliary second roller 113b, but may be provided in a similar way to other rollers. The safety mechanism could also be applied in all types of friction drives including state of art friction drives. Advantage of the safety mechanism is that it is easy to control and maintain, simple and cheap. FIG. 13a shows the safety mechanism in a free state being a free condition. FIG. 13b shows the safety mechanism in a locked state being a locked condition.

In the free state the upper auxiliary second roller 113b is in frictional engagement with the guide 3. The upper auxiliary second roller 113b is able to rotate along the guide and move in a downward direction seen from FIG. 13a. The upper auxiliary second roller 113b rotates around the second roller rotational axis 15b. An at least partly open sleeve 160 surrounds the upper auxiliary second roller 113b. The upper auxiliary second roller 113b is able to rotate around the second roller rotational axis 15b in the sleeve 160 preferably made from a metal. In other words an outer surface of the upper auxiliary second roller 113b moves with respect to an inner surface of the sleeve 160. Although some friction may occur between the upper auxiliary second roller 113b and the sleeve this friction is much less than the friction between the upper auxiliary second roller 113b and the second side running surface 10b. The sleeve 160 comprises a sleeve blocking opening 166. The sleeve blocking opening 166 is able to receive a blocking part 167 which is part of a control unit 165. The control unit 165 is suitable for actuating the blocking part 165. The control unit 165 is fixed to the frame 105 and can actuate the blocking part 167 in the sleeve blocking opening 166. This corresponds with the free state, as shown in FIG. 13a. The sleeve is now also fixed with respect to the frame 105.

As the upper auxiliary second roller 113b overcomes friction with the sleeve 160 it is able to move downwards or upwards by rotating around the second roller rotational axis 15b in a respective direction. This allows the carriage 5 to move upwards and downwards. In FIG. 13a, the carriage is moving downwards as indicated with a speed arrow V.

In the locked state, as shown in FIG. 13b, the control unit 165 can actuate the blocking part 167 out of the sleeve blocking opening 166. The actuation can for example be by means of a pre-strained spring that is released. The control unit 165 is configured to receive a carriage speed signal which is representative for a carriage speed with respect to the guide 3. Preferably, the safety mechanism comprises a speed measurement sensor configured to measure the carriage speed and provide the carriage speed signal representing the carriage speed to the control unit 165. In a further preference, the speed measurement sensor is an optical sensor arranged to the carriage and measuring a displacement of a side of the guide 3. For example, the optical sensor may be equivalent to a sensor used in an optical computer mouse, the measured surface being a side of the guide 3.

The control unit 165 is furthermore configured to generate a locking command for actuating the upper auxiliary second member 113b in the locking state as a function of the carriage speed. When the carriage speed exceeds a predetermined threshold the control unit 165 is configured to generate the locking command. This results in that the blocking part 167 is actuated out of the sleeve blocking opening 166.

When the blocking part 167 is out of the sleeve blocking opening 166, the sleeve 166 is not fixed anymore and the friction between the upper auxiliary second member 113b and the sleeve 160 results in the sleeve 160 rotating along with the upper auxiliary second member 113. The sleeve 160 is partly interrupted where the upper auxiliary second member 113b faces the second side running surface 10b. This interruption creates a lower blocking edge 164 where the sleeve 160 transits in the interruptions. As in the locking state the sleeve 160 rotates with the upper auxiliary second member 113, the lower blocking edge 164 moves with the rotation as well. The lower blocking edge 164 moves until it comes in contact with the second side running surface 10b. This results in locking or at least breaking the upper auxiliary second roller 113b with respect to the second side running surface 10b. The upper auxiliary second roller 113b encounters a counter force with respect to a direction of transport. This safety mechanism allows a safety stop when the carriage 5 is transported along the guide 3 with a carriage speed that is higher than the predefined threshold, being a safety speed value.

The stair lift according to the invention is not limited to the described embodiments. Any combination of described embodiments are possible and foreseen.

In an embodiment, the tyres are made from a material having a high friction coefficient such that the tyres can drive the carriage with respect to the guide. Moreover, tyres are made from wear-resistible synthetic material, wherein wear-resistible means longwearing and/or durable. For example the tyres are made from nylon or polyurethane.

Preferably, one or more of the rollers comprise a roller spindle which is made from metal. In an alternative, the roller spindle is made from synthetic material such as plastics.

In an alternative, the roller may be a belt with is driven by at least two drive rollers. This has as advantage that a more efficient stair lift may be possible. The belt is provided with an outer friction surface which is in frictional engagement with a running surface. This surface may extending along the length of the guide which may result in a large contacting surface between the outer friction surface and the running surface. This may result in more friction and a more efficient transport of the carriage.

In an alternative, the guide defines a variable angle with respect to a horizontal plane and/or a vertical plane along the length of the guide. This has as advantage that the stair lift may be used for any shape of staircase.

For example, the staircase may be a spiral staircase, which may result in a variable angle with respect to a vertical plane. In another example, the staircase may have a variable steepness which may result in a variable angle with respect to a horizontal plane. This variable angle is arranged along the length of the staircase.

In another alternative, not all rollers are driven by a drive.

In a further alternative, only one roller is driven by a drive.

In another alternative, the carriage is provided with a third roller, wherein the third roller comprises a third roller peripheral friction surface which is in frictional engagement with the second side running surface for guiding the carriage along the guide and the carriage is further provided with a first drive, a second drive and a third drive that are in a driveable connection with respectively the first roller, the second roller and the third roller such that the carriage is driveable by means of friction between the respective peripheral friction surfaces and the respective side running surfaces.

In a further alternative, the second roller friction surface is provided with a second roller member and the third roller friction surface is provided with a third roller friction surface.

In an alternative further alternative, the carriage comprises a fourth roller, wherein the fourth roller comprises a fourth roller peripheral friction surface which is in frictional engagement with the first side running surface for guiding the carriage along the guide and carriage is further provided with a fourth drive that is in a driveable connection with the fourth roller such that the carriage is driveable by means of friction between the fourth roller peripheral friction surface and the first side running surface.

In a further alternative, the fourth roller friction surface is provided with a fourth roller member.

In another alternative, tyres provided with roller members are rotatably connected with their rotational axis and are therefore not driven by the drive. These tyres may for example run in bearings.

In another alternative, more than one rollers provided with roller members are driven by one drive.

In another alternative, the sleeve 160 is made from a synthetic material, such as nylon or polyurethane.

In another alternative, circular recesses arranged in a frame rib can be any shape. For example rectangular, triangular, elliptical and/or oval.

In another alternative, a number of circular recesses arranged in a leg of a frame can be any number, such as 3, 4, 5, 6, 8, 9, 10.

In another alternative, a roller comprises any number of roller members, such as 1, 2, 3, 4, 5, 8, 10, 15, 20.

In another alternative, a side running surface comprises any number of side running surface members, such as 1, 2, 3, 4, 5, 8, 10, 15, 20, 40, 60.

In another alternative, a side running surface is arranged with side running surface members which are spaced from a topside to a downside.

In another embodiment, a roller comprises any number of roller members and a side running surface comprises any number of side running surface members, wherein the number of roller members is equal or less than the number of side running surface members.

In another alternative, a shape of roller members at an outer end may be any shape such as U-shaped or V-shaped or composed of multiple member side surfaces arranged at an angle with respect to an auxiliary plane perpendicular to a respective roller rotational axis.

In a further alternative, the shape of the roller members varies along its outer end and may for example be an undulated surface.

1. A stair lift for transporting a load, comprising;
a longitudinal guide comprising a first side running surface and a second side running surface opposing the first side running surface; and
a carriage which is transportable along the guide, provided with rollers for guiding the carriage along the guide, the carriage comprising:
a first roller comprising a first roller peripheral friction surface which is in frictional engagement with the first side running surface for guiding the carriage along the guide; and
a second roller comprising a second roller peripheral friction surface which is in frictional engagement with the second side running surface for guiding the carriage along the guide,
wherein the first roller friction surface is provided with a first roller member which peripherally extends in a plane perpendicular to a rotational axis of the first roller and the first side running surface is provided with a longitudinal first side running surface member which fits complementary with the first roller member for supporting the first roller on the first side running surface.

2. The stair lift according to claim 1, wherein the carriage is provided with a first drive that is in a driveable connection with the first roller such that the carriage is driveable by means of friction between the first roller peripheral friction surface and the first side running surface.

3. The stair lift according to claim 1, wherein the stair lift further comprises a load carrier, wherein a centre of gravity of the load carrier lies outwards from the second side running surface and wherein the first roller member and the complementary first side running surface member are arranged higher than the second roller and the second side running surface.

4. The stair lift according to claim 1, wherein the second roller friction surface is provided with a second roller member which peripherally extends in a plane perpendicular to a rotational axis of the second roller and the second side running surface of the guide is provided with a longitudinal second side running surface member which fits complementary with the second roller member for supporting the second roller along the second side running surface.

5. The stair lift according to claim 1, wherein the carriage is provided with a second drive that is in a driveable connection with the second roller such that the carriage is driveable by means of friction between the second roller and the second side running surface.

6. The stair lift according to claim 1, wherein the carriage is provided with a third roller, wherein the third roller comprises a third roller peripheral friction surface which is in frictional engagement with the second side running surface for guiding the carriage along the guide.

7. The stair lift according to claim 6, wherein the first roller is arranged in a direction along the guide between the second roller and the third roller.

8. The stair lift according to claim 6, wherein the carriage is provided with a fourth roller, and wherein the fourth roller comprises a fourth roller peripheral friction surface which is in frictional engagement with the first side running surface for guiding the carriage along the guide.

9. The stair lift according to claim 6, wherein the stair lift further comprises a load carrier, wherein a centre of gravity of the load carrier lies outwards from the second side running surface and wherein the first roller is arranged opposite to the third roller or the second roller.

10. The stair lift according to claim 1, wherein the carriage is free from active pressure means.

11. The stair lift according to claim 1, wherein the first roller member is a first roller flange and the first side running surface member is a first side running surface recess which receives the first roller flange.

12. The stair lift according to claim 11, wherein the first roller flange has a point shape outer end and the first side running surface recess has a complementary V-shape inner end.

13. The stair lift according to claim 1, wherein the first roller member is a first roller groove and the first side running surface member is a first side running surface ridge which is received by the first roller groove.

14. The stair lift according to claim 13, wherein the first roller groove has a point shape inner end and the first side running surface ridge has a complementary V-shape outer end.

15. The stair lift according to claim 1, wherein the first roller member comprises an upper member side surface and a lower member side surface, and wherein an upper member side surface angle defined between the upper member side surface and an auxiliary plane perpendicular to the rotational axis of the first roller is larger than a lower member side surface angle defined between the lower member side surface and the auxiliary plane.

16. The stair lift according to claim 1, wherein the first roller is provided with a plurality of first roller members and the first side running surface of the guide is provided with a plurality of first side running surface members which supports the plurality of first roller members.

17. The stair lift according to claim 1, wherein the guide comprises a topside and a downside and the carriage is free from rollers engaging on the topside and the downside.

18. The stair lift according to claim 1, wherein the guide is an aluminium extruded rail.

19. A method for transporting a load over a staircase by means of a stair lift, comprising:
providing the stair lift according claim 1; and
transporting the carriage along the guide from a start point to an end point.
